(19) United States
(12) Patent Application Publication
(10) Pub. No.: US 2023/0099946 A1
(43) Pub. Date: Mar. 30, 2023

(54) CURRENT COLLECTOR WITH VENT CHANNELS

(71) Applicant: Medtronic, Inc., Minneapolis, MN (US)

(72) Inventor: Joseph J. Viavattine, Vadnais Heights, MN (US)

(21) Appl. No.: 17/895,659

(22) Filed: Aug. 25, 2022

Related U.S. Application Data
(60) Provisional application No. 63/249,776, filed on Sep. 29, 2021.

(51) Int. Cl. H01M 4/70; H01M 4/38; H01M 50/30

(52) U.S. Cl. CPC H01M 4/70; H01M 4/382; H01M 50/30; H01M 2004/027

(57) ABSTRACT

A battery includes a positive electrode. The positive electrode includes a first current collector and a first active material. A negative electrode includes a second current collector. The second current collector includes at least one vent channel on at least one surface of the second current collector. The negative electrode includes a second active material.

### RELATED PATENT APPLICATION

This application claims the benefit of U.S. Provisional Patent Application Ser. No. 63/249,776, filed on Sep. 29, 2021, which is incorporated by reference herein in its entirety.

### FIELD

The present disclosure relates generally to the field of lithium batteries or cells.

### BACKGROUND

Lithium batteries or cells include one or more positive electrodes, one or more negative electrodes, and an electrolyte provided within a case or housing. Separators made from a porous polymer or other suitable material may also be provided intermediate or between the positive and negative electrodes to prevent direct contact between adjacent electrodes. The positive electrode includes a current collector having an active material provided thereon, and the negative electrode includes a current collector having an active material provided thereon.

### SUMMARY

Embodiments described herein involve a battery comprising a positive electrode. The positive electrode comprises a first current collector and a first active material. A negative electrode comprises a second current collector. The second current collector comprises at least one vent channel on at least one surface of the second current collector. The negative electrode comprises a second active material.

Embodiments involve a battery comprising a positive electrode. The positive electrode comprises a first current collector. A negative electrode comprises a second current collector. The second current collector comprises a first planar surface, a second opposing planar surface, and a first vent channel pattern disposed on the first planar surface on at least one surface of the second current collector. A second vent channel pattern is disposed on the second opposing planar surface of the second current collector. The first vent channel pattern is different than the second vent channel pattern.

Embodiments involve a method, comprising providing a current collector having a first planar surface and a second opposing planar surface. A mask is deposited on a portion of at least one of the first planar surface and the second opposing planar surface. An unmasked region is etched to create at least one vent channel.

Advantages and additional features of the subject matter of the present disclosure will be set forth in the detailed description which follows, and in part will be readily apparent to those skilled in the art from that description or recognized by practicing the subject matter of the present disclosure as described herein, including the detailed description which follows, the claims, as well as the appended drawings.

It is to be understood that both the foregoing general description and the following detailed description present embodiments of the subject matter of the present disclosure, and are intended to provide an overview or framework for understanding the nature and character of the subject matter of the present disclosure as it is claimed. The accompanying drawings are included to provide a further understanding of the subject matter of the present disclosure and are incorporated into and constitute a part of this specification. The drawings illustrate various embodiments of the subject matter of the present disclosure and together with the description serve to explain the principles and operations of the subject matter of the present disclosure. Additionally, the drawings and descriptions are meant to be merely illustrative and are not intended to limit the scope of the claims in any manner.

### BRIEF DESCRIPTION OF THE DRAWINGS

The following detailed description of specific embodiments of the present disclosure can be best understood when read in conjunction with the following drawings, in which:

FIG. 1 is a schematic cross-sectional view of a portion of a battery or cell according to an exemplary embodiment that includes at least one positive electrode and at least one negative electrode in accordance with embodiments described herein;

FIG. 2 illustrates an example of a current collector having holes disposed therein in accordance with embodiments described herein;

FIG. 3 illustrates a current collector having air entrapped between the current collector in accordance with embodiments described herein;

FIG. 4 illustrates an example having a current collector has one or more vents disposed on the surface of the current collector in accordance with embodiments described herein;

FIG. 5 shows a close-up view of the current collector with vents in accordance with embodiments described herein;

FIG. 6A shows an example of a current collector having vent channels that extend across the entire surface of the current collector in accordance with embodiments described herein;

FIGS. 6B and 6C illustrate examples of a current collector having one or more vent channels that do not extend across the entire surface of the current collector;

FIGS. 7A and 7B shows examples in which the vent channels are all connected on at least one of the first planar surface on the second planar surface in accordance with embodiments described herein;

FIGS. 8A-8D show examples of vent patterns that have one or more vents connected at a central region in the center of the current collector in accordance with embodiments described herein; and

FIG. 9 illustrates a process for forming one or more vent channels on a surface of a current collector in accordance with embodiments described herein.

### DETAILED DESCRIPTION

Reference will now be made in greater detail to various embodiments of the subject matter of the present disclosure, some embodiments of which are illustrated in the accompanying drawings. The figures are not necessarily to scale. Like numbers used in the figures refer to like components and steps. However, it will be understood that the use of a number to refer to a component in a given figure is not intended to limit the component in another figure labeled with the same number. In addition, the use of different numbers to refer to components in different figures is not intended to indicate that the different numbered components cannot be the same or similar to other numbered components.

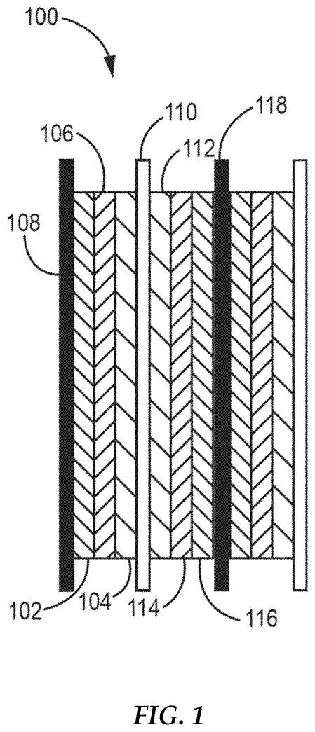

FIG. 1 is a diagram of an example electrochemical cell 100 in accordance with embodiments. The electrochemical cell 100 includes at least one first electrode 102 separated from a first side of a second electrode 104 by a separator 106. According to various embodiments, the separator 106 is a shutdown separator. The first electrode 102 can comprise a first current collector 108 substrate having a first active material composite layered thereon. The first current collector 108 can be substantially planar, or the first current collector 108 can be curved, although embodiments are not limited thereto. The second electrode 104 can comprise a second current collector 110 substrate parallel to the first current collector 108 substrate. The second current collector 110 substrate can have a second active material composite layered thereon. The second current collector 110 can be substantially planar, although embodiments are not limited to planar current collectors. More than one set of electrodes can be included in the electrochemical cell 100. For example, current collector 110 can have active material disposed thereon to form a third electrode 112. A second separator 114 can separate a second side of the second electrode 112 from a first side of the third electrode 116. The third electrode 116 can be formed by disposing active material on current collector 118. While FIG. 1 illustrates a planar cell 100 embodiments are not limited thereto. Other embodiments include but are not limited to the cell being coiled or rolled up.

The separator 106 can be resistant to heat distortion. The separator 106 may be porous such that lithium ions can pass through the separator. The separator 106 may include a resin or other material that melts or deforms at high temperatures to close pores of the separator 106. According to various embodiments, pore shutdown may prevent passage of lithium ions, shutting down the electrochemical cell 100 current to zero or nearly zero. In some examples, a subset of separators 106 will shut down.

In some examples, the first electrode 102 can be a negative electrode and the second electrode 104 can be a positive electrode. Positive electrodes 104 can include an active material and a sheet-form current collector (e.g., current collector 110) carrying the active material. The positive electrode current collector 110, can typically comprise a metal but is not limited thereto. For the positive electrode 104, 112 active material, various materials can be used. The positive electrode 104 can include a material mixture carried on the current collector 110, the material mixture including a positive electrode active material and a small amount of a binder or a conductive material. Positive electrode 104 active material can include lithium-containing transition metal oxides such as lithium cobalt oxide, lithium nickel oxide, and lithium manganese oxide. The binder material can include polytetrafluoroethylene (PTFE) or rubber materials. Negative electrode 102 can include an active material and a sheet-form current collector 108 carrying the active material. The negative electrode active material may include one or more of silver vanadium oxide (SVO), carbon monofluoride (CFx), and/or mixtures thereof. The negative electrode current collector 108 can typically comprise a metal but is not limited thereto. The negative electrode active material can include carbon materials (for example, graphite), a silicon material or silicon alloy, a tin material or a tin alloy, and lithium metal. The lithium metal can include a lithium alloy including metal elements such as aluminum, zinc or magnesium. The negative electrode 102 binder material can include the same or similar material as used in the positive electrode 104 binder material.

Current collectors (e.g., current collector 108 and 110) may include current collector tabs (not shown), which are coupled, typically by welding, to respective current collectors and then provided outside the battery cell casing so that the electrochemical cell 100 energy can be transferred to an external source.

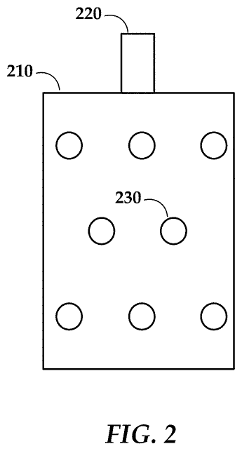

According to various configurations, one or more of the current collectors provided with holes to facilitate adhesion with the respective electrode anode. For example, anode current collectors are provided with holes to facilitate adhesion with the anode. FIG. 2 illustrates an example of a current collector 210 having holes 230 disposed therein in accordance with embodiments described herein. The current collector has a tab 220 that allows the device to be connected to an external source. The holes may extend all the way through the current collector. In some cases, the holes are configured to extend only partially through the thickness of the current collector.

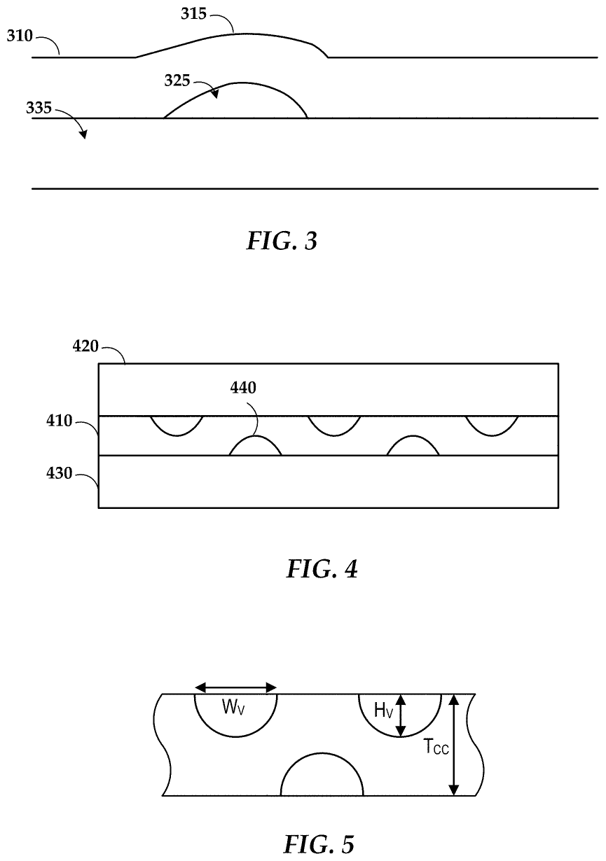

Current collectors pressed with holes to facilitate adhesions can result in air being entrapped when lithium is pressed on both sides of the collector, for example. In some cases, current collectors without holes can also result in air being entrapped. FIG. 3 illustrates a current collector 310 in accordance with embodiments described herein. When the current collector 310 is pressed onto the electrode 335, air 325 is trapped between the current collector 310 and the electrode 335. This results in the current collector warping 315 causing the current collector 310 to have an uneven surface. This uneven surface may cause the current collector 310 to have poor adhesion to one or both of the lithium layers.

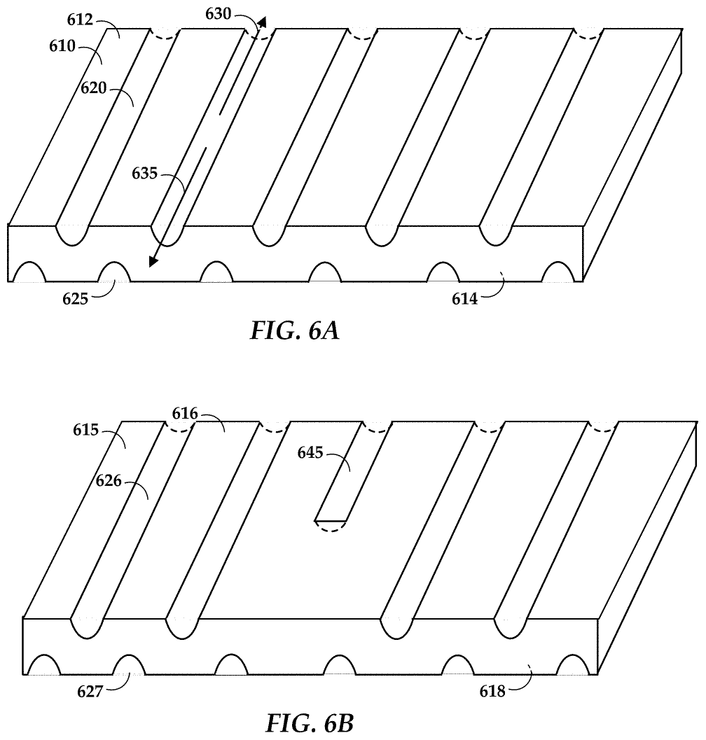

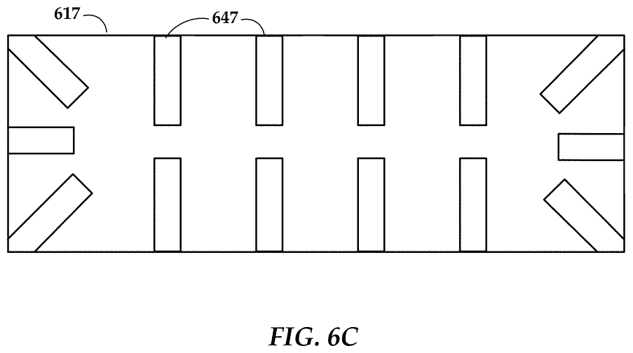

A collector without holes was thought to eliminate this issue, but still there can be pockets of air that get trapped and the adhesion is generally worse when the collector has no holes. Embodiments described herein involve a current collectors having a pattern of holes with vent channels between holes or some holes and with some vent channels eventually reaching the periphery of the collector. FIG. 4 illustrates an example having a current collector 410 that has one or more vent channels 440 disposed on the surface of the current collector in accordance with embodiments described herein. In this example, the current collector is disposed between two layers 420, 430 of electrode material (e.g., lithium).

Titanium anode collectors are generally etched from both sides. To create a hole, the unmasked region is etched from both sides. To create a channel between the holes, on one side only, one side is fully masked and the other is unmasked for the channel. The channel would end up having a depth that is about half the thickness of the collector. This could better ensure that air can leave the holes and reduce the volume of entrapped air.

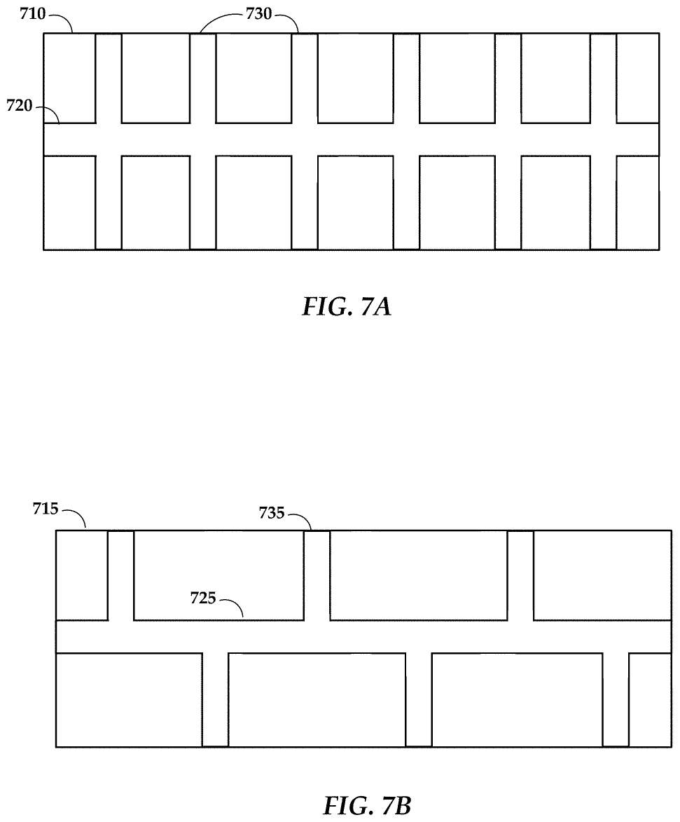

The vent channels in a current collector can have different patterns. A vent pattern on a first planar side of the current collector may be different than a vent pattern on a second opposing planar side of the current collector. FIG. 6A shows an example of a current collector 610 having vent channels 620, 625 that extend across the entire surface of the current collector 610 in accordance with embodiments described herein. The vent channels 620, 625 extend to the periphery of the current collector 610 allowing air to escape along the direction of arrows 630, 635. In this example, first vent channels 620 are disposed on a first planar surface 612 and second vent channels 625 are disposed on a second planar surface 614. The vent channels 620, 625 may be configured to alternate such that they do not overlap.

FIGS. 6B and 6C show examples of current collectors 615, 617 having one or more vent channels 645, 647 that do not extend across the entire surface of the respective current collector 615, 617. Specifically, FIG. 6B shows vent channels 626 disposed on the first planar surface 616 and vent channels 627 disposed on the opposing second planar surface 618. A single vent channel 645 that does not extend across the entire first planar surface 616 is shown. In some cases, more than one vent channel may not extend across the surface as shown in the example of FIG. 6C.

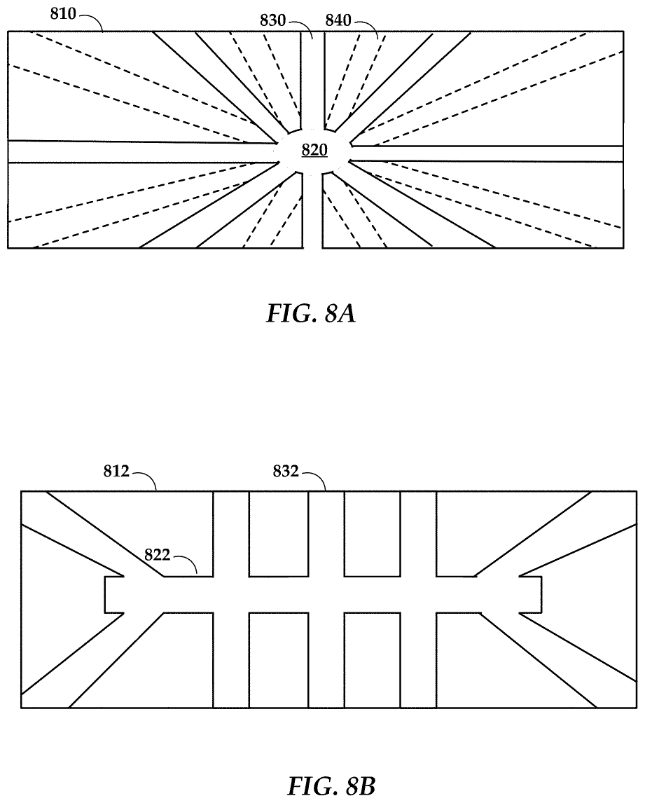

FIGS. 7A and 7B shows examples in which the vent channels 730, 735 are all connected on at least one of the first planar surface on the second planar surface in accordance with embodiments described herein. In these examples, the vent channels 730 disposed on a current collector 710, 715 are connected by a central vent channel 720, 725 that runs along a longitudinal axis of the respective current collector 710.

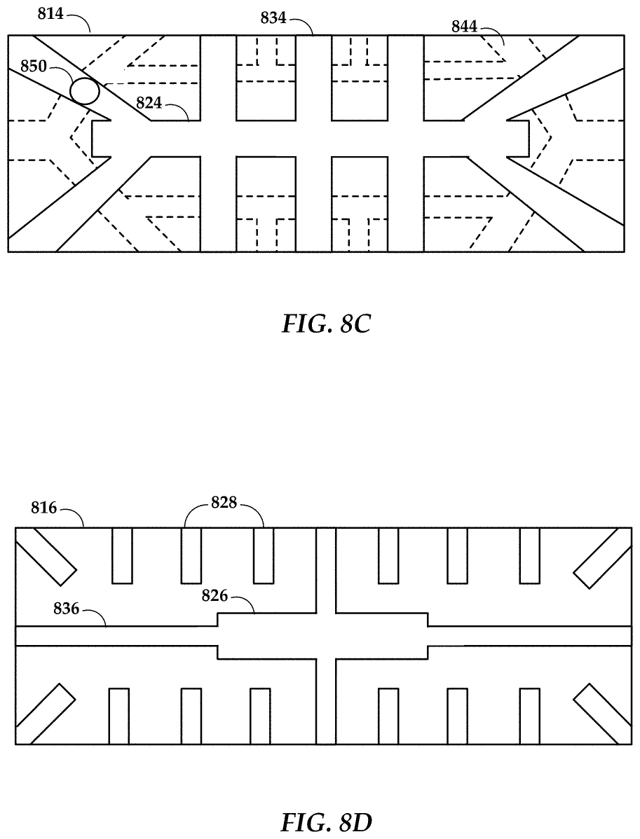

FIGS. 8A-8C show examples of vent patterns that have one or more vent channels connected at a central region in the center of the current collector in accordance with embodiments described herein. FIG. 8A shows a current collector 810 having a central vent 820 disposed on the first planar surface. One or more vents 830 extend from the central vent 820 to the periphery of the current collector 810. One or more vent channels 840 indicated by dotted lines may be disposed on the second opposing planar surface of the current collector 810. The second opposing planar surface may or may not have a central vent similar to that of the central vent 820 disposed on the first planar surface. FIG. 8B illustrates another example of a current collector 812 having one or more vents 832 extending from a central vent 822 in accordance with embodiments described herein.

FIG. 8C shows another example of a first vent pattern disposed on a first planar surface of a current collector. The first vent pattern includes one or more vent channels 834 extending from a central vent 824. In this example, a second vent pattern 844 is disposed on the second planar surface of the current collector 814. In areas where the first vent pattern and the second vent intersect (e.g., 850), the vent channels may extend through the entire thickness of the current collector 814. This may allow additional opportunities for air to escape. In some cases, the first vent pattern and the second vent pattern do not intersect.

FIG. 8D illustrates another example of a current collector 816 having one or more vent channels 836 extending from a central vent 826. One or more additional vent channels 828 are disposed along the periphery of the current collector 816. The one or more additional vent channels 828 extend partially through the surface of the current collector.

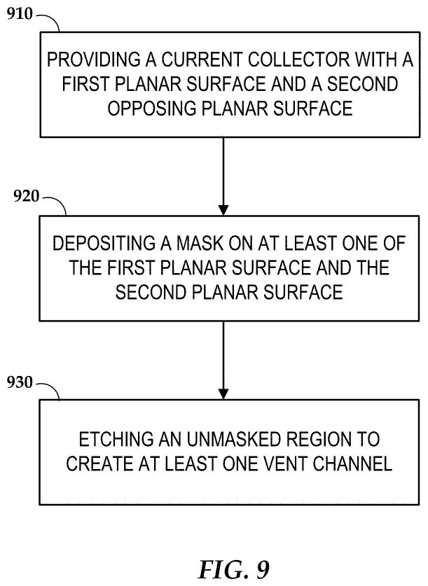

FIG. 9 illustrates a process for forming one or more vent channels on a surface of a current collector in accordance with embodiments described herein. A current collector having a first planar surface and a second opposing planar surface is provided 910. A mask is deposited 920 on a portion of at least one of the first planar surface and the second opposing planar surface. The mask creates a masked portion and an unmasked portion. The unmasked portion is etched 930 to create at least one vent channel.

According to various embodiments, the mask is deposited on a portion of both of the first planar surface and the second opposing planar surface. The at least one vent channel may be configured to prevent air from being trapped between the second current collector and an active material of the negative electrode. The at least one vent channel may be configured to facilitate adhesion between the second current collector and the negative electrode. The at least one vent channel may be configured to reach a periphery of at least one of the first planar surface and the second opposing planar surface. The at least one vent channel may have a depth that is about half a thickness of the current collector.

The invention is defined in the claims. However, below there is provided a non-exhaustive list of non-limiting examples. Any one or more of the features of these examples may be combined with any one or more features of another example, embodiment, or aspect described herein.

Example Ex1: A battery comprising: a positive electrode comprising a first current collector and a first active material; a negative electrode comprising: a second current collector comprising at least one vent channel on at least one surface of the second current collector; and a second active material.

Example Ex2: The battery as in example Ex1, wherein the at least one vent channel is configured to prevent air from being trapped between the second current collector and the second active material.

Example Ex3: The battery as in any one of examples Ex1 to Ex2, wherein the negative electrode comprises lithium.

Example Ex4: The battery as in any one of examples Ex1 to Ex3, wherein the at least one vent channel is configured to facilitate adhesion between the second current collector and the negative electrode.

Example Ex5: The battery as in any one of examples Ex1 to Ex4, wherein the second current collector has a first planar surface and a second opposing planar surface and at least one first vent channel is configured to be disposed on the first planar surface and at least one second vent channel is configured to be disposed on the second opposing planar surface.

Example Ex6: The battery of example Ex5, further comprising, wherein the at least one first vent channel and the at least one second vent channel intersect at one or more points

Example Ex7: The battery of example Ex5, wherein the at least one first vent channel and the at least one second vent channel do not intersect.

Example Ex8: The battery as in any one of examples Ex1 to Ex7, wherein the at least one vent channel is configured to reach a periphery of the at least one surface of the second current collector.

Example Ex9: The battery as in any one of examples Ex1 to Ex8, wherein the at least one vent channel has a depth that is about half a thickness of the second current collector.

Example Ex10: The battery as in any one of examples Ex1 to Ex9, wherein the at least one vent channel comprises a channel pattern comprising a plurality of channels that connect at a central location on the at least one surface.

Example Ex11: A battery comprising: a positive electrode comprising a first current collector; a negative electrode comprising: a second current collector comprising: a first planar surface; a second opposing planar surface; a first vent channel pattern disposed on the first planar surface on at least one surface of the second current collector; and a second vent channel pattern disposed on the second opposing planar surface of the second current collector, the first vent channel pattern being different than the second vent channel pattern.

Example Ex12: The battery as in example Ex11, wherein at least one of the first vent channel pattern and the second vent channel pattern is configured to prevent air from being trapped between the second current collector and an active material.

Example Ex13: The battery as in any one of examples Ex11 to Ex12, wherein the negative electrode comprises lithium.

Example Ex14: The battery as in any one of examples Ex11 to Ex13, wherein at least one of the first vent channel pattern and the second vent channel pattern is configured to facilitate adhesion between the second current collector and an active material.

Example Ex15: A method, comprising: providing a current collector having a first planar surface and a second opposing planar surface; depositing a mask on a portion of at least one of the first planar surface and the second opposing planar surface; and etching an unmasked region to create at least one vent channel.

Example Ex16: The method as in example Ex15, further comprising depositing a mask on a portion of both of the first planar surface and the second opposing planar surface.

Example Ex17: The method as in any one of examples Ex15 to Ex16, wherein the at least one vent channel is configured to prevent air from being trapped between the current collector and an active material.

Example Ex18: The method as in any one of examples Ex15 to Ex17, wherein the at least one vent channel is configured to facilitate adhesion between the current collector and an active material.

Example Ex19: The method as in any one of examples Ex15 to Ex18, wherein the at least one vent channel is configured to reach a periphery of at least one of the first planar surface and the second opposing planar surface.

Example Ex20: The method as in any one of examples Ex15 to Ex19, wherein the at least one vent channel has a depth that is about half a thickness of the current collector.

All scientific and technical terms used herein have meanings commonly used in the art unless otherwise specified. The definitions provided herein are to facilitate understanding of certain terms used frequently herein and are not meant to limit the scope of the present disclosure.

As used herein, singular forms “a,” “an” and “the” include plural referents unless the context clearly dictates otherwise. As used in this specification and the appended claims, the term “or” is generally employed in its sense including “and/or” unless the content clearly dictates otherwise. The term “and/or” means one or all of the listed elements or a combination of any two or more of the listed elements.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the inventive technology.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred. Any recited single or multiple feature or aspect in any one claim can be combined or permuted with any other recited feature or aspect in any other claim or claims.

It will be apparent to those skilled in the art that various modifications and variations can be made to the present inventive technology without departing from the spirit and scope of the disclosure. Since modifications, combinations, sub-combinations and variations of the disclosed embodiments incorporating the spirit and substance of the inventive technology may occur to persons skilled in the art, the inventive technology should be construed to include everything within the scope of the appended claims and their equivalents.

What is claimed is:

1. A battery comprising:
a positive electrode comprising a first current collector and a first active material;
a negative electrode comprising:
a second current collector comprising at least one vent channel on at least one surface of the second current collector; and
a second active material.

2. The battery of claim 1, wherein the at least one vent channel is configured to prevent air from being trapped between the second current collector and the second active material.

3. The battery of claim 1, wherein the negative electrode comprises lithium.

4. The battery of claim 1, wherein the at least one vent channel is configured to facilitate adhesion between the second current collector and the negative electrode.

5. The battery of claim 1, wherein the second current collector has a first planar surface and a second opposing planar surface and at least one first vent channel is configured to be disposed on the first planar surface and at least one second vent channel is configured to be disposed on the second opposing planar surface.

6. The battery of claim 5, further comprising, wherein the at least one first vent channel and the at least one second vent channel intersect at one or more points

7. The battery of claim 5, wherein the at least one first vent channel and the at least one second vent channel do not intersect.

8. The battery of claim 1, wherein the at least one vent channel is configured to reach a periphery of the at least one surface of the second current collector.

9. The battery of claim 1, wherein the at least one vent channel has a depth that is about half a thickness of the second current collector.

10. The battery of claim 1, wherein the at least one vent channel comprises a channel pattern comprising a plurality of channels that connect at a central location on the at least one surface.

11. A battery comprising:
a positive electrode comprising a first current collector;
a negative electrode comprising:
a second current collector comprising:
a first planar surface;
a second opposing planar surface;
a first vent channel pattern disposed on the first planar surface on at least one surface of the second current collector; and
a second vent channel pattern disposed on the second opposing planar surface of the second current collector, the first vent channel pattern being different than the second vent channel pattern.

12. The battery of claim 11, wherein at least one of the first vent channel pattern and the second vent channel pattern is configured to prevent air from being trapped between the second current collector and an active material.

13. The battery of claim 11, wherein the negative electrode comprises lithium.

14. The battery of claim 11, wherein at least one of the first vent channel pattern and the second vent channel pattern is configured to facilitate adhesion between the second current collector and an active material.

15. A method, comprising:
providing a current collector having a first planar surface and a second opposing planar surface;
depositing a mask on a portion of at least one of the first planar surface and the second opposing planar surface; and
etching an unmasked region to create at least one vent channel.

16. The method of claim 15, further comprising depositing a mask on a portion of both of the first planar surface and the second opposing planar surface.

17. The method of claim 15, wherein the at least one vent channel is configured to prevent air from being trapped between the current collector and an active material.

18. The method of claim 15, wherein the at least one vent channel is configured to facilitate adhesion between the current collector and an active material.

19. The method of claim 15, wherein the at least one vent channel is configured to reach a periphery of at least one of the first planar surface and the second opposing planar surface.

20. The method of claim 15, wherein the at least one vent channel has a depth that is about half a thickness of the current collector.
